(19) United States
(12) Patent Application Publication
(10) Pub. No.: US 2005/0100855 A1
(43) Pub. Date: May 12, 2005

(54) Flexible triple tray with hinged elements

(76) Inventor: Neal B. Gittleman, Houston, TX (US)

Correspondence Address: EZRA L. SCHACHT, 1620 WEST MAIN STREET, HOUSTON, TX, 77006-4712, US

(21) Appl. No.: 10/703,124

(22) Filed: Nov. 6, 2003

(51) Int. Cl. A61C 9/00

(52) U.S. Cl. 433/38

(57) ABSTRACT

An apparatus and method to avoid dental impression material distortion comprised of dental impression triple tray with a flexible hinge rendered inflexible by the curing of a polymer impression compound. Accurate simultaneous impressions of upper and lower impressions and bite registration, with the mouth completely closed and the jaw accurately positioned in centric closure are insured. Spring back of the impression tray frame caused by bite pressure against points on the frame are minimized by allowing the hinge element to initially flex when first placed in the mouth. The impression polymer cures to render the hinged area inflexible.

### BACKGROUND OF THE INVENTION

In the field of dentistry, patient comfort and the efficient use of a dentist's time are paramount. Likewise, precision alignment of prosthetic components is essential. The need to match, both natural and artificial, upper and lower teeth to within less than 10 microns and provide accurate mating of the prosthesis with existing teeth requires accurate replication of oral structures when making dental impressions. To create these accurate models and the final prosthesis, a matched upper and lower impression can be obtained simultaneously with the jaw in the closed position and the teeth in the interdigitated position (centric occlusion). A triple tray is used to simultaneously register the upper and lower bite while making simultaneous upper and lower impressions of dental and soft tissue structures. Most triple trays currently on the market are molded as a single piece from a rigid thermoplastic compound. This plastic may be stressed or distorted during the taking of the impression by the bite pressure and has the tendency to spring back and exert a distorting pressure on the flexible impression material after the triple tray is removed from the mouth. This misshapen impression material will result in an ill-fitting prosthesis. The present invention remedies this oversight.

As an example of conventional existing practice, the following procedures are performed when preparing an implant prosthesis. After dental implants have healed into the underlying bone structures of the mandible or maxilla and the soft gum tissue has healed, a full set of upper and lower impressions of the mouth are made using individual full or partial arch upper and lower trays. Positive casts of these impressions are mounted upon a mechanical articulator that mimics the motion of the temporo-mandibular joint (tmj). A separate bite registration cast is also made. These positive casts are equipped with accurately placed implant fixture analogs positioned to accurately replicate the structures in the mouth. These positive casts are tested against the bite registration cast.

In the conventional procedure, the healing caps are removed from one or more dental implant fixtures and impression transfer posts are accurately attached to each implant fixture. An impression tray filled with a self-hardening elastomeric impression material is pressed over the region of the dental arch containing the impression transfer posts.

After a few minutes, the elastomeric impression material has set and the impression is removed with a gentle parting pressure. The impression transfer post snaps from its positive detent within the impression material. Then the impression transfer post is unscrewed from the implant and attached to an implant analog with the screw. The healing cap is replaced on the dental implant. The analog of the dental implant is accurately attached to the impression transfer post that was snapped back into the elastomeric impression material. The same procedure is followed for the opposing dental arch. A third, bite registration impression is taken without the impression transfer posts installed and the teeth in centric closure.

A stone model of the mouth structure with the dental implant analog exactly aligned and retained is created from the separate impressions. These models are combined upon an articulator to mimic the actual jaw motions. A model of the final prosthesis is built up and tried in for a non-interfering, good fit. This model, relying upon properly placed dental implant analogs cast in the properly aligned position, is used to build the final prosthesis.

In the improved procedure, in order quickly to make an accurate, simultaneous impression of the upper and lower teeth in the correct alignment, the practitioner uses a ‘triple tray.’ This tray consists of a molded plastic assembly with a handle connected to a set of confining dams and a thin open screen mesh. The mesh is oriented horizontally and is to be placed between the mating occlusal surfaces of the teeth while the jaw is in the closed or centric position. The buccal and lingual dams of the frame are molded to the mesh. A paste of quick-setting elastomer is placed on both sides of the mesh within the confines of the dams. The mouth is closed with the upper and lower teeth in the closed or centric position while imbedded within the curing elastomer. In this manner, a matching set of aligned upper and lower impressions along with the proper bite registration are made.

The elastomeric impression materials, such as polyvinylsiloxane or polyether, are dimensionally stable, but are flexible to allow removal from the teeth and the stone replicas. If the triple tray was distorted during the taking of the impression, the replica will not be true. Likewise, the impression transfer post position cannot be ensured and thus accurate replication of the implant within the models mounted upon the articulator will be compromised. If low profile impression transfer posts in combination with the triple tray are used, accurate registry of the elastomeric impression to the dental implant analog occurs. Instead of taking three time-consuming, separate impressions of the upper arch, lower arch and bite registration, a single impression is formed, thus, the ‘triple tray’ name. If a single area of the partially edentulous mouth is being modeled, a half-arch, triple tray can be used.

The preferred embodiment of this invention has at least two stiff, molded portions of the triple tray frame bridged by a flexible coined hinge assembly acting as a stress-relieving member. The two portions of the frame are continuous except for the horizontal mesh and a distal bend having a flexible coined hinge assembly. When the impression is taken, the coined hinge first bends to allow the rigid frame sections to accommodate the displacing forces from surrounding tissues while the impression polymer is curing and secures the frame portions as one essentially rigid piece.

### A BRIEF DESCRIPTION OF THE DRAWINGS

FIG. 1 (prior art) details a perspective view of a quadrant triple tray;

FIG. 2 shows a perspective view of a triple tray with included coined hinges assembly forming a flexible distal bend in the triple tray frame;

FIG. 3 is a plan view of a serpentine spiral assembly forming a flexible distal bend;

FIG. 4 details an alternate perspective view of the serpentine flexible hinge;

FIG. 5 shows a close up perspective view of the flexible spiral hinge; and

FIG. 6 shows a perspective view of single flexible member of limited cross-section to act as a bending hinge element.

### S DESCRIPTION OF THE DRAWINGS

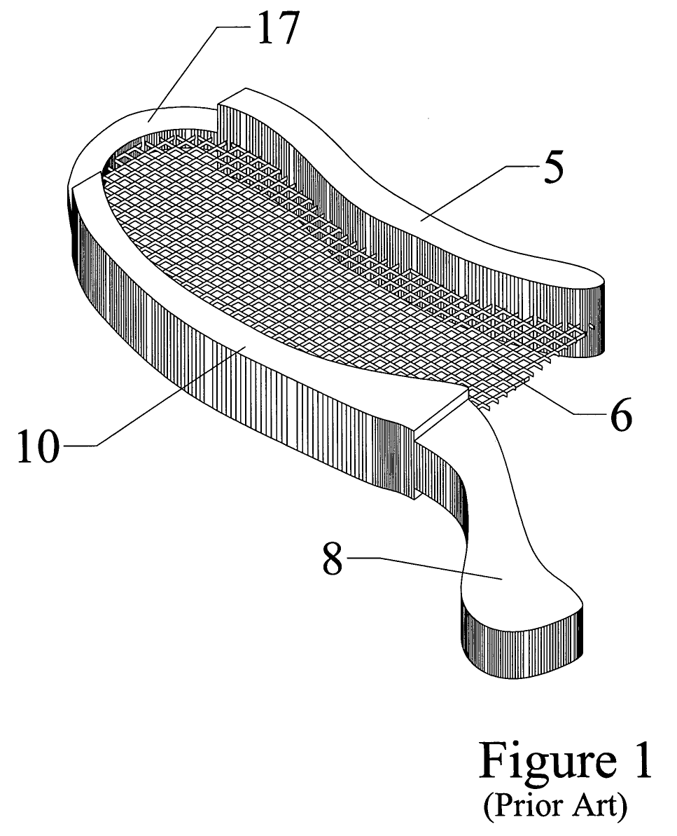

A fairly accurate model can be simultaneously fabricated from an impression of the upper and lower jaws with remaining natural teeth and dental implants by means of a triple tray. FIG. 1 (prior art) shows a typical molded plastic anterior triple tray with handle 8, curved outer buccal dam wall 10, curved inner lingual dam wall 5 and horizontal open mesh 6. Transition region 17 is a thinned but rigid curved frame member that holds both dam walls rigidly in place. Region 17 is modified in this invention to improve the art. A quick setting polymer paste is placed in an arc on both upper and lower sides of the mesh. The dentist places the triple tray in the patient's mouth and closes the jaw in a natural occluded, centric position. The thin loose mesh 6 conforms to the touching occlusal surfaces of the upper and lower teeth while the polymer completely enfolds the teeth, implants and other oral structures to form an accurate impression. However, pressures at points on the triple tray frame caused by portions of the oral anatomy can deform the triple tray resulting in a less than accurate impression when the tray springs back to the un-occluded shape when it is removed from the mouth. If the main problem is distortion of the triple tray, then the solution is to balance the forces to arrive at an acceptable equilibrium.

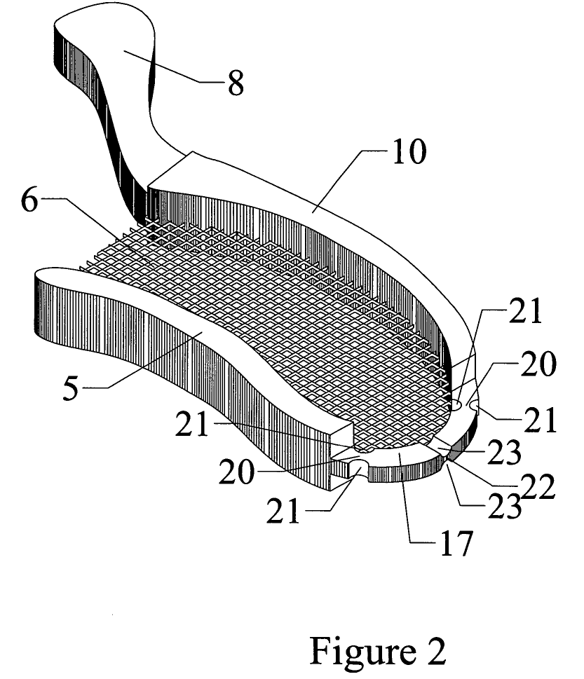

FIG. 2 embody the preferred improvements in triple tray design by including a flexible hinge region 17 formed in a thinned region of the triple tray frame. A series of horizontal and vertical coined hinges act to impart flexibility to arc region 17. Hinge 20 is formed with notches 21 on at least one face of region 17 to flex upon demand in the horizontal x-y plane of the mesh 6. Similarly coined hinge 22 is formed with notches 23 on at least one face of thinned region 17 to flex upon demand in a vertical x-z direction. The combination of horizontal and vertical hinges allows rigid frame elements 5 and 10 to accommodate to structures in the mouth during centric closure without interference.

If the thinned plastic arc of plastic is coined with thinned sections, in an alternate vertical and horizontal pattern, then it will flex upon closure. How much pressure the return to the non-closure position exerts is more than overbalanced by the semi-rigidity of the polymer impression material. By choosing the flexure of the coined hinges at the time of manufacture of the triple tray, the impression polymer will not be distorted beyond a micron or two. This is well within required tolerances for the finest dental reconstructions.

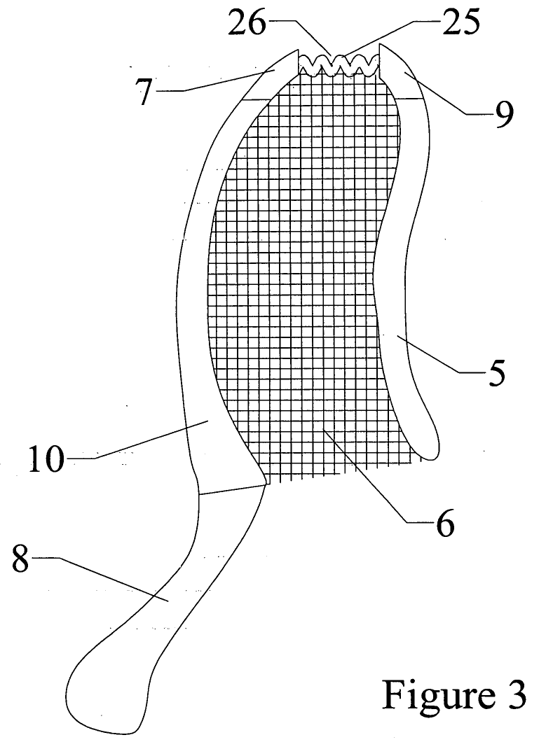

FIG. 3 shows a plan view of the modified triple tray with a spiral flexible member in the distal arch region of the molded frame. Arch elements 7 and 9 are joined by a serpentine region with loops 25 and spaces 26 to flex and stretch in all directions to allow frame to accommodate structures in the mouth during centric closure.

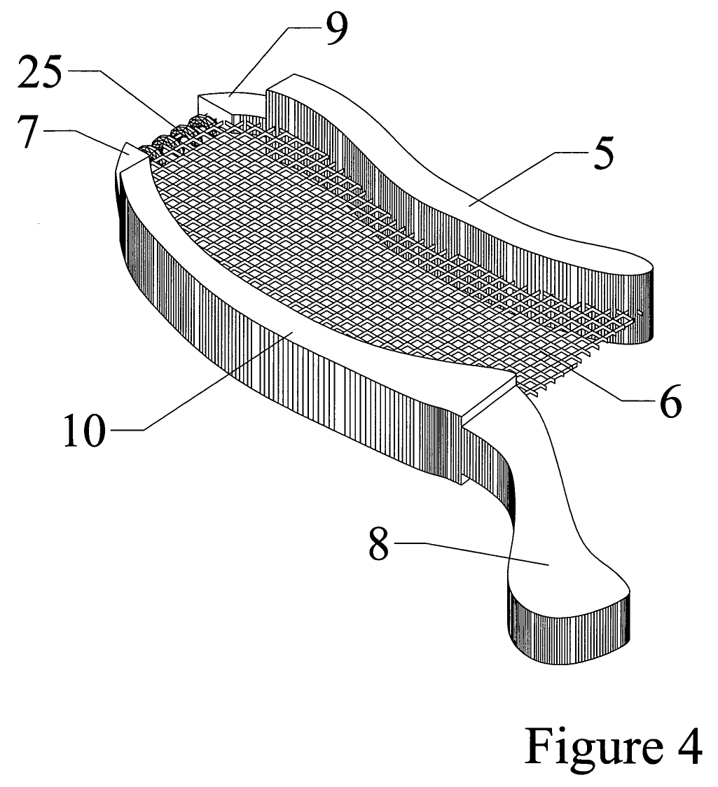

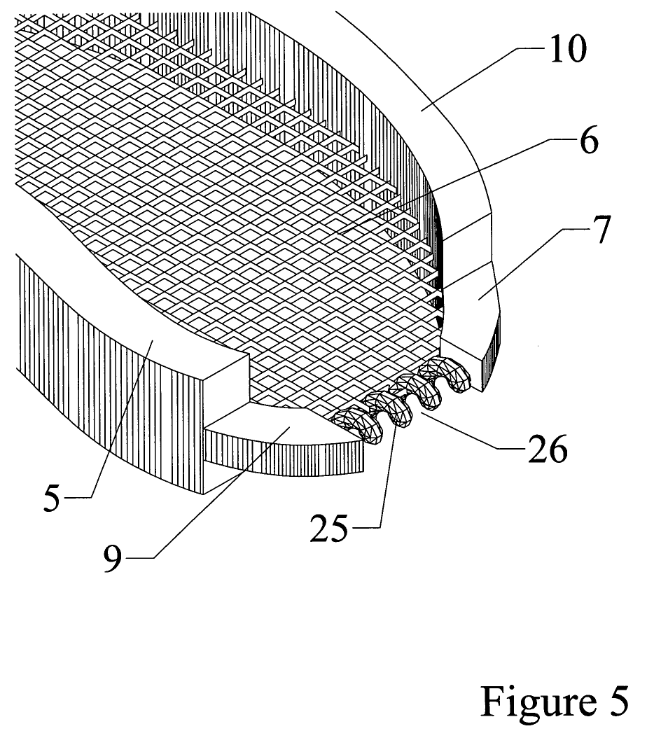

FIG. 4 is a perspective view of the flexible triple tray with the spiral, spring shaped distal element 25 shown joining frame portions 7 and 9. FIG. 5 shows a close up of the spiral flexible element with coils 25 and intervening spaces 26.

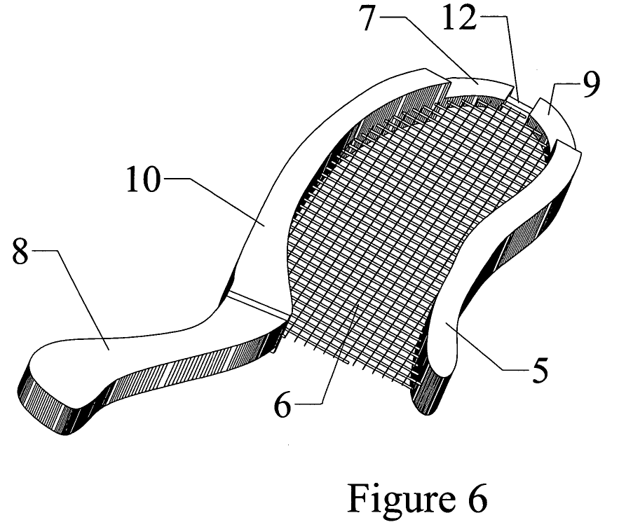

FIG. 6 shows a perspective view of a modified triple tray with a single, flexible fiber region 12 joining frame elements 7 and 9. This flexible fiber region 12, having a limited cross section, bends in several directions to allow the frame to adjust to mouth structures during closure. The cured polymer impression material will hold the frame elements 10 and 5 in the centric closure position without distorting the shape of the impression material.

1. A dental implant registration apparatus comprising an impression tray having
a curved frame;
a horizontal mesh;
said curved frame having a flexible distal bend;
and an impression polymer compound;
said flexible distal bend rendered inflexible by the curing of said impression polymer compound during centric closure.

2. An apparatus as cited in claim 1 comprising said distal bend having a set of coined hinges formed in said flexible distal bend.

3. An apparatus as cited in claim 1 comprising said distal bend having a serpentine flexible hinge.

4. An apparatus as cited in claim 1 comprising said distal bend having a spiral flexible hinge.

5. An apparatus as cited in claim 1 comprising said distal bend having a single flexible fiber.
